(19) United States
(12) Patent Application Publication
(10) Pub. No.: US 2026/0057734 A1
(43) Pub. Date: Feb. 26, 2026

(54) GAMING MANAGEMENT SYSYTEM AND RELATED DEVICES AND METHODS

(71) Applicant: LNW Gaming, Inc., Las Vegas, NV (US)

(72) Inventors: Victor Blanco, Las Vegas, NV (US); Donovan Meyer, Las Vegas, NV (US)

(21) Appl. No.: 19/307,890

(22) Filed: Aug. 22, 2025

Related U.S. Application Data
(60) Provisional application No. 63/687,195, filed on Aug. 26, 2024.
(60) Provisional application No. 63/703,455, filed on Oct. 4, 2024.

(51) Int. Cl. G07F 17/32; G06V 20/52

(52) U.S. Cl. CPC G07F 17/3223; G06V 20/52; G07F 17/322; G07F 17/3227

(57) ABSTRACT

A game management system may comprise a game management device including one or more processors and a non-transitory computer-readable medium storing instructions thereon that, when executed by the one or more processors, cause the one or more processors to detect a plurality of different peripheral devices connected to the game management device, select a game-type from a plurality of game-types, determine a game-state of the selected game-type, receive data from one or more peripheral devices of the plurality of different peripheral devices, and update the game-state responsive to the data received from the one or more peripheral devices.

### CROSS-REFERENCE TO RELATED APPLICATIONS

This application claims the benefit under 35 U.S.C. § 119(e) of U.S. Provisional Patent Application Ser. No. 63/703,455, filed Oct. 4, 2024, and U.S. Provisional Patent Application Ser. No. 63/687,195, filed Aug. 26, 2024, the disclosure of which is hereby incorporated herein in its entirety by this reference.

### TECHNICAL FIELD

This disclosure relates generally to gaming management systems for managing one or more peripheral devices connected to a gaming management device.

### BACKGROUND

Casino gaming environments are often dynamic, with individuals such as players, casino patrons, and casino staff taking actions that affect the state of the gaming environment. As one example, a player may use one or more physical tokens to place wagers on a wagering game. As another example, a player may perform hand gestures to perform gaming actions and/or to communicate instructions during a game, such as gestures to hit, stand, or fold. In yet another example, a player may move physical cards, dice, gaming props, and so on. A multitude of other changes may occur at any given time.

Each game may also use one or more devices to aid in the execution of a given game. For example, a card game at a casino gaming table may include a card shoe to shuffle and deal cards to players. In addition, the card game may employ cameras to identify players or cards held by each of the players. Each of these devices typically operates separately without knowledge of the actions of the other device(s), thereby increasing the complexity of operating the game using the separate devices. Such complexity may lead to mistakes by a dealer, increased training costs, and/or less engagement from players.

### BRIEF SUMMARY

Some embodiments of the disclosure include a game management system. The gaming management system comprises a game management device including one or more processors and a non-transitory computer-readable medium storing instructions thereon that, when executed by the one or more processors, cause the one or more processors to detect a plurality of different peripheral devices connected to the gaming management device, select a game-type from a plurality of game-types, determine a game-state of the selected game-type, receive data from one or more peripheral devices of the plurality of different peripheral devices, and update the game-state responsive to the data received from the one or more peripheral devices.

Further embodiments of the disclosure include a method of operating a wagering game system including a gaming table and a gaming management device. The method comprises detecting a plurality of peripheral devices connected to the gaming management device, selecting a game-type from a plurality of game-types detecting a game-state of the selected game-type, receiving data from one or more peripheral devices of the plurality of peripheral devices, and updating the game-state responsive to the data received from the one or more peripheral devices.

Further embodiments of the disclosure include a game management system. The game management system includes a plurality of peripheral gaming devices, a server comprising a non-transitory computer-readable medium storing one or more applications corresponding to different table games, and a game management device in communication with the server. The game management device includes one or more processors and a non-transitory computer-readable medium storing instructions thereon that, when executed by the one or more processors, cause the one or more processors to detect the plurality of peripheral gaming devices connected to the gaming management device, select a game-type from a plurality of game-types, request, from the server, one or more applications corresponding to the selected game-type, receive the one or more applications from the server, and provide, based on the one or more applications, gaming data to one or more peripheral game devices of the plurality of peripheral gaming devices.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a schematic diagram of a game management system according to one or more embodiments of the disclosure;

FIG. 2 is a schematic diagram of a headless card shoe showing interaction between the headless card shoe and the game management device in accordance with one or more embodiments of the disclosure;

FIG. 3 is a flowchart of a method of operation of a game management system according to one or more embodiments of the disclosure;

FIG. 4 is a flowchart of a method of operation of a game management device according to one or more embodiments of the disclosure;

FIG. 5 shows an example configuration of a game management system in accordance with one or more embodiments of the disclosure;

FIG. 6 is a schematic block diagram of an illustrative gaming management system for implementing wagering games according to this disclosure; and

FIG. 7 is a block diagram of circuitry that, in some examples, may be used to implement various functions, operations, acts, processes, and/or methods disclosed herein.

### DETAILED DESCRIPTION

Conventional casino gaming environments employ multi-functional systems designed to facilitate a variety of casino games. For example, conventional casino gaming tables may employ a plurality of peripheral devices to facilitate one or more game-types (e.g., blackjack, poker, baccarat, and so on), each of which may require unique rules or betting systems. Furthermore, conventional casino gaming tables may employ other peripheral devices to track and/or monitor aspects of the casino gaming environment, such as credit balance, player account information, player movements, game play events, and the like.

As each peripheral device may have been purchased from a different manufacturer, the peripheral devices typically cannot communicate with each other to work in concert for a specific game-type being played at the gaming table. If the peripheral devices are able to communicate with each other, they are typically cumbersome and difficult to configure in order to do so. For example, a gaming table may implement a progressive betting system from one provider which incorporates signage and betting spots arranged around the table, and also incorporate a card shoe from a different provider or manufacturer. In this arrangement, the card shoe is typically unaware of a game-state for a given game-type and cannot communicate information between the card shoe and the progressive betting system and/or the signage.

Accordingly, in one or more embodiments of the disclosure, in order to allow a plurality of peripheral devices used for playing a game (e.g., a casino game) to act in concert for a given game-type, a game management device that provides and receives data from the plurality of peripheral devices to update one or more of the devices based on a game-state of a chosen game-type may be provided.

According to one or more embodiments, a game management system may include a game management device in communication with a plurality of peripheral devices, where the game management device provides data to and receives data from one or more of the plurality of peripheral devices. The game management device may also be in communication with a game management server hosting a plurality of applications (e.g., game applications) configured to drive one or more game-types that may be played (e.g., at a casino game table). In this arrangement, the game management system may receive an application based on a selected game-type from the game management server and communicate data corresponding to the received application to the plurality of peripheral devices. The data may include data relating to a game-state of a game resulting from executing the received application.

By using the game management device to provide data to and receive data from the plurality of peripheral device, the game management system may allow for each of the plurality of devices to act in concert with each other. The devices may act in concert with each other to provide game relevant data (e.g., data relating to a game-state of a selected game application) between each other via the game management device. For example, actions taken by one peripheral device may cause changes to be reflected in others of the plurality of peripheral devices (e.g., a change in game-state detected by one peripheral device may cause a graphic displayed on a separate peripheral display device to be changed).

The ability of each device of a game environment, such as a casino game table environment, to communicate information between each other may allow for an enhanced player experience. It may also allow additional information to be communicated to each player, the dealer, a floor manager, and/or back of house (BOH) personnel or operation as compared to conventional systems.

Furthermore, by allowing the game management device to provide data to the plurality of peripheral devices, each of the plurality of peripheral devices may be configured to have one or more peripheral device operations to be controlled by the game management device. This may allow for the production of peripheral devices without costly independent control circuitry within each of the peripheral devices. This may also reduce integration difficulties between each of the plurality of peripheral devices for a given game-type via the game management device.

Additionally, by allowing game-relevant data to be communicated from each peripheral device to the game management device, games with complex game rules and/or complex wagering systems may be managed by the game management device to allow dealers to deal the games with less training than that typically required for conventional casino game systems.

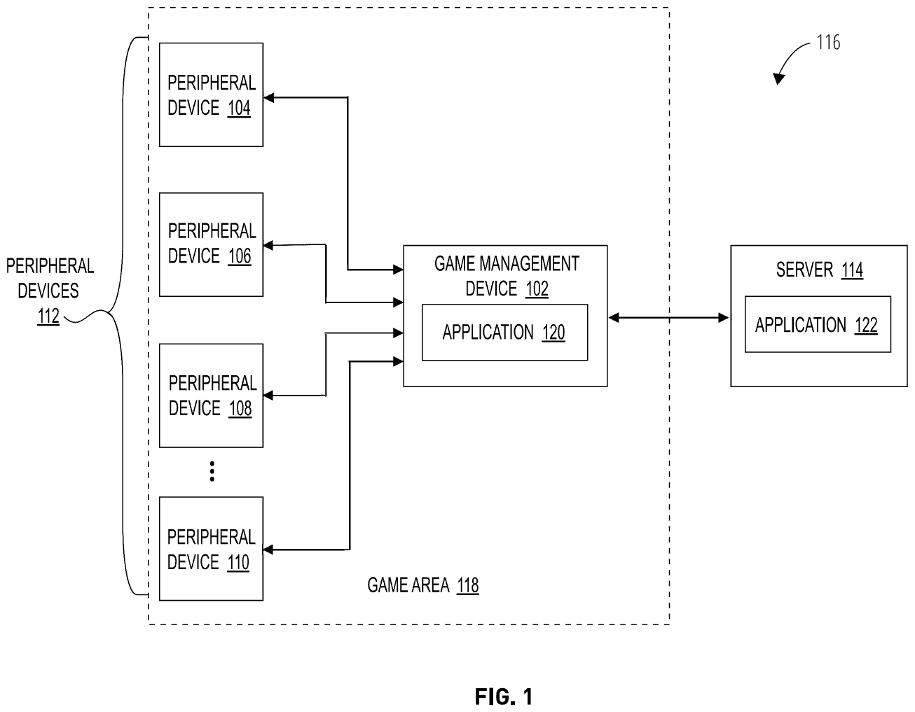

FIG. 1 is a schematic diagram of a game management system 116 according to one or more embodiments of the disclosure. The game management system 116 includes a game management device 102 and peripheral devices 104, 106, 108, and 110, referred to collectively as peripheral devices 112, that are in communication with the game management device 102. In some embodiments, the game management device 102 and the peripheral devices 112 may be placed on or proximate to a game area 118, where the game area 118 may include a gaming table (e.g., a casino gaming table). The game management system 116 may also include a server 114 in communication with the game management device 102. The game management device 102 may include an application 120 and the server 114 may include an application 122, where the application 120 of the game management device 102 may be configured to interface with (e.g., make requests to and receive data from) application 122 of the server 114.

In some embodiments, the peripheral devices 112 may include one or more of a variety of different types of peripheral devices, such as a light emitting diode (LED), a signage display (e.g., an electronic display for game information, which may include betting information and information relating to a current game-state of a game being played), a dealer display, a per-player display (e.g., virtual bet spots, player bank, and casino system features such as information relating to loyalty programs and advertising), an LED controller (e.g., a table lighting or signage lighting), a card shuffler and/or card shoe, a progressive bet spot, a chip recognition system (e.g., a video camera, an RFID reader, and so on), a card recognition system (e.g., a video camera), a player recognition system (e.g., a video camera, an NFC sensor, a card magnetic strip sensor, and so on), an audio transducer (e.g., audio speakers and/or subwoofers), an audio capture device, an image projection device, and an image capture device (e.g., image or video camera), without limitation. Although the discussion herein is with reference to specific peripheral devices types, any known device used in casino gaming environments may be included as one of the peripheral devices 112. Furthermore, any number of peripheral devices may connect to the game management device 102.

The game management device 102 may include a controller, one or more network devices (e.g., Ethernet, WI-FI®, or BLUETOOTH® devices, without limitation), one or more data ports (e.g., serial, Universal Serial Bus (USB), digital Input/Output (I/O), without limitation) and/or one or more digital display devices. For example, in some embodiments the game management device 102 may be in the form of a laptop or desktop computer or computer tower. In additional examples, the game management device 102 may be in the form of any other suitable computing device such as, but not limited to, a hand-held device, such as a tablet device, a mobile phone device, and/or any other suitable computing device.

Similarly, the server 114 may be in the form of any suitable computing device such as, but not limited to, a desktop computer, computer tower, tablet device, mobile phone device, and/or any other suitable computing device. Additionally, the server 114 may also include one or more network devices (e.g., Ethernet, WI-FI®, or BLUETOOTH® devices, without limitation) and one or more data ports (e.g., serial, USB, digital I/O, without limitation). WI-FI® is a registered trademark of the Wi-Fi Alliance of Austin, Texas, USA. BLUETOOTH® is a registered trademark of the Bluetooth Special Interest Group (SIG), Inc., of Kirkland, Washington, USA.

In some embodiments, the game management device 102 may store or have access to one or more player accounts. Each player account may be associated with bio-identification information, such as facial data, used to identify the player via captured image data. Each player account may also be associated with loyalty program information that may track game play history and monetary wins and losses of the player associated with the player account.

Each of the peripheral devices 112 may be connected to the game management device 102. For example, each of the peripheral devices 112 may connect to the game management device 102 wirelessly (e.g., via WI-FI®, BLUETOOTH®, etc.) and/or through a wired connection (e.g., Ethernet, USB, or other digital I/O mediums). Furthermore, the game management device 102 may be connected to the server 114 via a wireless and/or a wired connection. In some embodiments, the server 114 may be located proximate to (e.g., locally, such as within a same building as) the game management device 102. In other embodiments, the server 114 may be remote from the game management device 102.

In some embodiments, at least one of the peripheral devices 112 may be in the form of a camera configured to capture a video feed of the game area 118. The captured video feed may then be provided to the game management device 102 for further processing. For example, the game management device 102 may be configured to identify and/or track (e.g., via a neural network or other image recognition techniques) one or more players and/or one or more game objects or game pieces (e.g., betting chips and/or cards) present in the game area 118.

In some embodiments, the data received from the camera may be used to update a game-state of the selected game-type. Responsive to the updated game-state, the game management device 102 may then send updated data to one or more of the peripheral devices 112. In some embodiments, the data sent from the game management device 102 may include audio and/or image data.

Additionally, the game management device may control at least some functionality of at least one of the peripheral devices 112 responsive to the updated game-state. For example, in the case that peripheral device 104 is a card shoe, the game management device 102 may cause the card shoe to begin to dispense cards when a determination is made that the initial begging phase has ended.

The application 120 may be a client application installed on the game management device 102. In one or more embodiments, the application 120 may be associated with the game management system 116. For example, the application 120 may enable execution of one or more game applications corresponding to a game-type (e.g., a casino game-type). Furthermore, the application 120 may also facilitate sending data to and receiving data from each of the peripheral devices 112. In some embodiments, the application 120 may be configured to adapt one or more game functions based on detected peripheral devices of the peripheral devices 112. In addition, the game management device 102 may operate dynamically based on the type of peripheral device connected to the game management device 102.

For example, in some embodiments, peripheral device 104 may be in the form of a camera and the peripheral device 106 may be in the form of a card shoe. In some embodiments where the camera is connected but the card shoe is not connected, the game executed via the application 120 may require knowledge of cards dealt at a table. If the game management device 102 detects that no card shoe is detected, but a camera is, the game management device 102 may identify cards via image data captured by the camera 504 and use the information to identify cards in the game area, and may then provide that information to the game application. Furthermore, if both the camera and the card shoe are detected, the application 120 may default to providing information derived from image data received from the card shoe to identify cards. Thus, the game management device 102 may define primary and secondary devices which may both perform the task of providing image data to the game management device 102 to identify cards in a game environment and, if the primary device is not detected as being connected, fall back on the secondary device that is detected as connected to provide the necessary data. According to this example, the game management device 102 operates dynamically based on the type of peripheral device connected to the game management device.

The application 122 may be a server application installed on the server 114. In one or more embodiments, the application 122 may implement an interface by which the application 120 may request one or more game applications or game application related data.

For example, in some embodiments, the application 122 may be in the form of a game store platform hosting any number of game applications created by any number of parties or organizations. The application 122 may allow a user to use the game management device 102 to select from a list of games stored on the server 114 or that are retrievable by the server 114. Each game stored on the server may also require the user of the game management device 102 to select additional data associated with the game. For example, each game may have associated compatible side bets, progressive bets, game rule or betting customization options, graphical presentation customization options, without limitation. Furthermore, the server may also receive, from the game management device 102, an indication of what peripheral devices are connected to the game management device 102 and automatically select or indicate which game-types or customization options are available based on what peripheral devices are connected to the game management device 102.

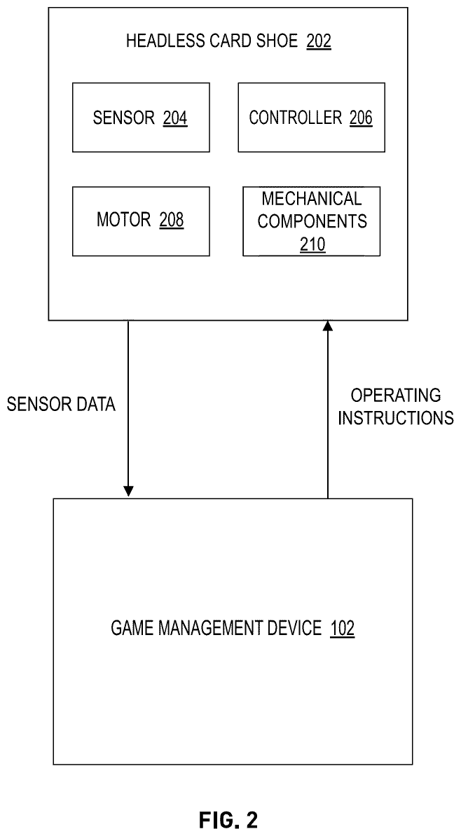

FIG. 2 is a schematic diagram of a headless card shoe 202 showing interaction between the headless card shoe 202 and the game management device 102 in accordance with one or more embodiments of the disclosure. The headless card shoe 202 may be one of the peripheral devices 112 shown in FIG. 1. The headless card shoe 202 may include sensors 204, motor 208, mechanical components 210 and controller 206. The mechanical components 210 and the motor 208 may be used to manipulate one or more cards stored in the headless card shoe 202. For example, the headless card shoe 202 may be configured to shuffle and/or deal cards stored in the headless card shoe 202. The sensor 204 may be in the form of an optical sensor or other image acquisition device configured to capture image data corresponding to a card within the headless card shoe 202. For example, the sensor 204 may provide image data of a card within or being extruded by the headless card shoe to the game management device 102. Though discussed in terms of the sensor 204 being an optical sensor, any type of sensor may be used to detect acquire data relating to a card stored in the headless card shoe 202. For example, the sensor may include RFID or magnetic strip sensors, without limitation.

The controller 206 may receive operating instructions from the game management device 102 where the operating instructions may cause the controller to drive mechanical functions of the headless card shoe 202, such as dealing a card, locking a card, or locking the device. Data from the card shoe (e.g., image data from the sensor 204) may be provided to the game management device 102. The game management device 102 may, based on the received image data, identify a suit and/or number of the card represented in the image data. The image data may include data pertaining to a bar code, marker, or other card identifiers of the card captured in the image data. In some embodiments, other data may be sent from the headless card shoe 202 to the game management device 102 such as error information. The game management device 102 may process the error information and handle messaging, reporting, and diagnostics of the headless card shoe 202.

Referring to FIGS. 1 and 2 together, by offloading the control logic of the headless card shoe 202 into the game management device 102, the game management device 102 is able to receive information detected by the headless card shoe 202 (such as which cards are about to be dealt, are being dealt, or already have been dealt), which may be used to update other aspects of a game currently being played. This allows the game management system 116 to track which cards are dealt to which player and, in conjunction with data received from other peripheral devices (e.g., one or more others of peripheral devices 112), allows the game management device 102 to better track and manage a game (e.g., updating a game-state for a selected game-type). This provides a more immersive experience for a player while also enabling automatic tracking for complex game rules and wagering systems to provide a more accessible game system for a dealer.

More particularly, such processing may enable a dealer having less training to manage a selected game-type as compared to what may typically be required of a dealer using conventional game systems. For example, the game management device may log detailed data relating to at least game outcomes, hands per hour, game performance, equipment status, and so on, aggregate the data for analytics, and provide the aggregated data and/or the results of the analytics to the dealer via a display device. Providing this information may offer additional game insights to the dealer in real-time or at specific game-states of a given game-type (e.g., at the end of a game).

Furthermore, by utilizing the game management device 102 to provide data including operating parameters to one or more of the peripheral devices 112, the peripheral devices may no longer require reconfiguration when one of the peripheral devices 112 (e.g., the headless card shoe 202) is moved to a new game or to a new table, a procedure which is typically difficult and cumbersome to perform using conventional systems.

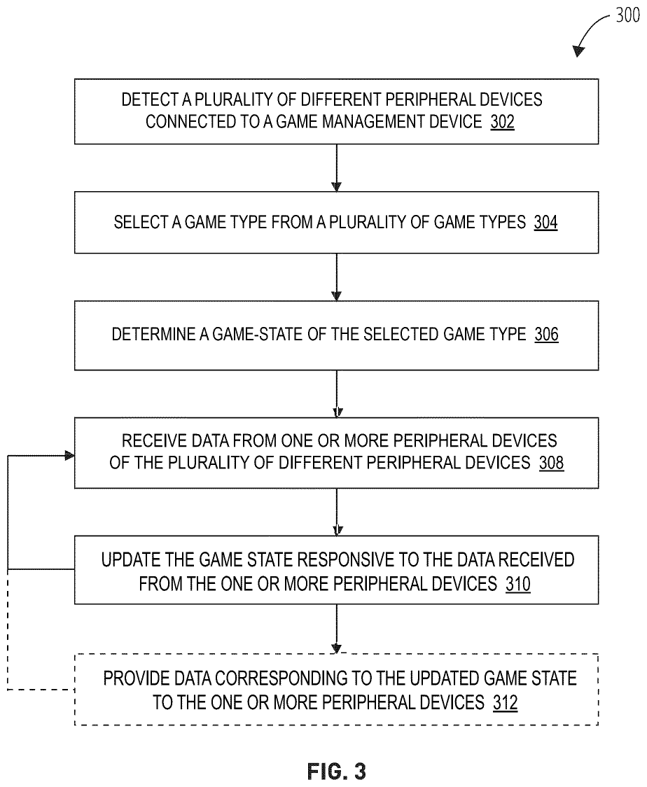

FIG. 3 is a flowchart of a method 300 of operation of a game management system according to one or more embodiments of the disclosure. In some embodiments, method 300 may be performed by a game management system (e.g., the game management system 116 of FIG. 1) including a processor executing instructions stored on a computer-readable storage medium. In FIG. 3, one or more variations or embodiments of a simplified sequence-flow used to select and manage a game application based on data received from the peripheral devices 112 are indicated.

At operation 302, the game management system 116 detects a plurality of different peripheral devices (e.g., peripheral devices 112) connected to a game management device (e.g., game management device 102). For example, the game management device 102 may detect peripheral devices connected via a wired or wireless connection, store an indication of a peripheral device type, and interface with each peripheral device. In some embodiments, the application 120 may be configured to allow the game management device 102 to interface with each peripheral device.

In some embodiments, the application 120 may be configured to store a list of approved (e.g., types of) peripheral devices to which the game management device 102 is approved to connect with. Conversely, the application 120 may be configured to store a list of restricted or prohibited (e.g., types of) peripheral devices to which the game management device 102 is not approved to connect with. When the application 120 of game management device 102 detects that a peripheral device connected to the game management device 102 is not on the list of approved peripheral devices, or on the list of restricted or prohibited peripheral devices, the application may restrict or prohibit the peripheral device from interfacing with (e.g., sending data to or receiving data from) the game management device 102.

Additionally, the application 120 may allow the game management device 102 to track a type of peripheral device connected to the game management device 102. For example, the game management device 102 may be able to provide identification for each connection port of the game management device 102 and its associated type of peripheral device (e.g., and/or specific identifier of the peripheral device). For example, if a camera is connected to port 0 (e.g., the first port in an array of ports) of the game management device 102, the application 120 of the game management device 102 may store an indication of the peripheral device and its associated port 0, where the indication includes information identifying the peripheral device as a camera (e.g., and/or specific identifier of the peripheral device or camera). In some embodiments, additional indicators may be stored in association with the indication of the peripheral device indicating further details (e.g., operational or functional features) of the peripheral device. For example, such additional indications in the case that the peripheral device is a camera may indicate whether the camera is configured to capture a live video feed.

At operation 304, the game management system 116 may select a game-type from a plurality of game-types. In some embodiments, the game management device 102 may select a game-type from a plurality of game applications stored on the game management device 102. As a specific non-limiting example, a user device or user input device may be connected to the game management device 102. The game management device 102 may provide to the user device or the user input device a list of available game-types and a user may select an available game-type from the list. Furthermore, in some embodiments, the game management device 102 may select a game-type from a plurality of game applications stored on the server 114. For example, the game management device 102 may provide a list of game-types available on the server 114 to the user device or the user input device. The game management device 102 may then, responsive to a user selection, request a game application from the server 114 based on the selected game-type.

Each of the plurality of game applications may have one or more associated settings for customizing a game of the selected game-type. For example, selecting a game-type from a game stored at the game management device 102 or the server 114 may include selecting compatible side bets, progressive bets, customized rule settings, graphics designs for display in one or more of a variety of different types of ways (e.g., on an electronic display or projected onto the game area 118 via a projection device, or displayed on one or more embedded table devices such as virtual bet spots, or other variables associated with game-types typically played in a casino environment). Each of the associated settings may also be selectable at the user device or the user input device when the user is making a game-type selection.

In some embodiments, the game management device 102 and/or the server 114 may limit the game-types to be selected based on the detected one or more peripheral devices. For example, the application 120 may detect that the game management device 102 is connected to a camera, a transducer, and a subwoofer, but not to a card management device such as a card shoe. Based on the detection, the application 120 may limit selection of the game-type to game-types that do not typically require a card management device. In the case that the game is selected from the server 114, the application 120 may provide to the application 122 a list of peripheral devices connected to the game management device 102. Based on the provided list of connected peripheral devices, the application 122 may limit selection of the game application stored on the server to game applications that do not use a peripheral device not in the provided list of connected peripheral devices.

Additionally, some game applications may be customized based on available peripheral devices. For example, some game-types may require one type of peripheral device or an alternative peripheral device. As a specific example, a game-type may require a way to identify cards placed on a surface of the game area 118. Here, the game application associated with the game-type may require either a camera capable of providing image data to the game management device 102 or an NFC sensor system configured to detect cards placed on the surface of the game area 118. If either of these devices is detected, then the game-type is available to be selected. In some embodiments, if both the camera and the NFC sensor system are detected, the game application associated with the game-type may be configured to prioritize use of the camera system and use the NFC sensor system if the camera is not present. Furthermore, in some embodiments, if both the camera and the NFC sensor system are detected then the game application may be configured to incorporate data from both the camera and the NFC sensor system to determine a game-state of the game-type associated with the game application.

Furthermore, the application 120 and/or the application 122 may provide one or more additional or fewer customizable options for a selected game application based, at least in part, on the detected one or more peripheral devices. For example, the selection of graphics to display via an electronic display and/or a projector may vary based on whether or not an electronic display and/or a projector device is detected to be connected to the game management device 102.

At operation 306, the game management device 102 may determine a game-state of the selected game-type. For example, after the game management device 102 selects and/or receives a game application (e.g., one stored on the game management device 102 or received from the server 114), the game management device 102 may execute the game application to generate an initial game-state of the game application. In some embodiments, the initial game-state of the game application may be generated based on one or more parameters provided by the game management device 102 and/or the server 114. The one or more parameters may include the number of players, active player accounts associated with identified players, initial wagers, progressive bets, and/or valid bets, without limitation. The game management device 102 may also provide data related to the initial game-state to the one or more peripheral devices. For example, the game management device 102 may provide video, audio, and lighting data to an electronic display, transducer and/or subwoofer, and projector device, respectively, where each of the camera, transducer and/or subwoofer, and projector device are detected peripheral devices.

At operation 308, the game management system 116 receives data from one or more of the peripheral devices. The game management device 102 may receive indications from the one or more peripheral devices of game information or activity. For example, the indications of game information or activity may be indications of a wager, a wager amount, cards dealt, video information, gestures or actions by one or more players, card information in relation to each player, without limitation. In some embodiments, one of the peripheral devices 112 includes a card management device (e.g., a card shoe) that may communicate data (e.g., image data or other sensor data) to the game management device 102.

At operation 310, the game management device 102 updates the game-state responsive to the data received from the one or more peripheral devices. Based on the data received from the one or more peripheral devices, the game management device 102 may determine wins, losses, cards held by each player, increased or decreased chances of winning for each player, bet increases, bet increase amounts, payouts, without limitation. In some embodiments, the game management device 102 may, based on information received by the peripheral devices 112, calculate a win probability for each player.

In some embodiments, the game management device 102 may provide information received from one peripheral device of the peripheral devices 112 to others of the peripheral devices 112. For example, in the case that peripheral device 104 is a camera and peripheral device 106 is an electronic display device, the game management device 102 may provide image data received from the camera and provide the image data to the electronic display device for display.

At operation 312, the game management system 116 may provide data corresponding to the updated game-state to one or more of the peripheral devices 112. For example, based on the determinations of the game management device 102, the game management device 102 may automatically provide audio, video and/or lighting data (or other visuals) to the peripheral devices 112. For example, the game management device 102 may provide video information that may indicate a win probability to a peripheral device in the form of an electronic display device. Furthermore, the game management device 102 may, responsive to detection of a “win” condition, provide audio, video and/or lighting data (or other visual) related to the win condition to one or more of the peripheral devices 112. After updating the game-state and/or providing data to the peripheral devices 112, the game management system 116 may then return to operation 308 and receive additional data from the peripheral devices 112.

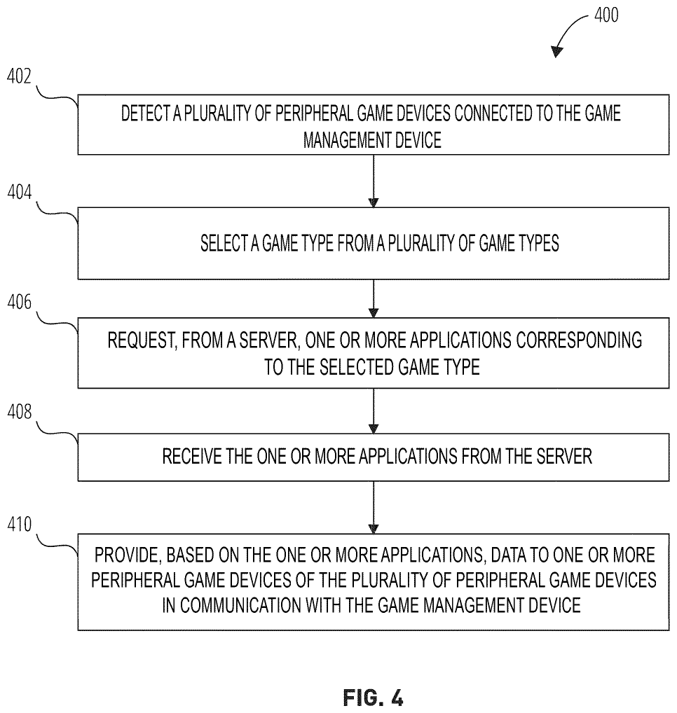

FIG. 4 is a flowchart of a method 400 of operation of a game management device according to one or more embodiments of the disclosure. In some embodiments, method 400 may be performed by a game management device (e.g., game management device 102 of FIG. 1) including a processor executing instructions stored on a computer-readable storage medium.

At operation 402, the game management system 116 may detect a plurality of peripheral game devices connected to the game management device 102.

At operation 404, the game management device 102 may select a game-type from a plurality of game-types. For instance, the game management device 102 may be in connection with a user device. The game management device 102 may cause the user device to display a game-type selection screen to the user device and may thereby receive, from a user, a selection of a game-type.

At operation 406, the game management system 116 may request from a server (e.g., server 114) one or more applications corresponding to the selected game-type. For example, based on the selected game-type, the game management device 102 may send a request for a game application stored on the server 114 where the game application corresponds to the selected game-type.

At operation 408, the game management device 102 may receive the one or more applications from the server.

At operation 410, the game management device 102 may provide data to one or more peripheral game devices of the plurality of peripheral game devices in communication with the game management device. The data may be based on the one or more received game applications. For example, the game management device 102 may send audio and/or video data to the peripheral devices 112.

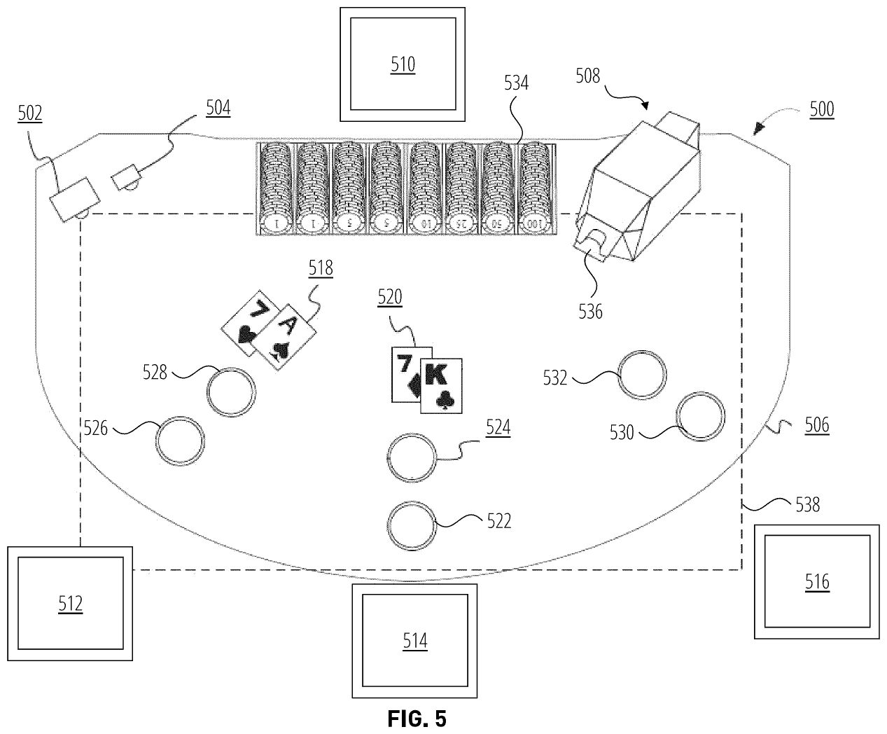

FIG. 5 shows an example configuration of a game management system 500 in accordance with one or more embodiments of the disclosure. The game management system 500 includes a gaming table 506, a camera 504, a projector 502, a card handling device 508, a dealer display device 510, and player display devices 512, 514, and 516. The dealer display device 510 and the player display devices 512, 514, and 516 may be in the form of a hand-held device (e.g., a smartphone or tablet device) or other computing device (e.g., a desktop device), such that each of the player display devices 512, 514, and 516 and the dealer display device 510 may be configured to receive a user input via a touch screen or other input device. Each of the camera 504, the projector 502, the card handling device 508, the dealer display device 510, and the player display devices 512, 514, and 516 may be connected, either via a wired or wireless connection, to a game management device. The game management device may be located beneath or proximate to the gaming table 506. The camera 504 may capture a stream of images of an area encompassing a surface of the gaming table 506, such as game area 538. The projector is configured to project gaming content, including images of outcome indicators. The projector may project the images toward the surface of the gaming table relative to objects in the game area. The gaming table 506 may include player spots for players to participate in games at the table. For example, a first player spot may include first main betting spot 526, and first secondary betting spot 528 as well as player display device 512. A second player spot may include main betting spot 522 and secondary betting spot 524 as well as player display device 514. A third player spot may include main betting spot 530 and secondary betting spot 532 as well as player display device 516.

A specific example of operation of the game management system 500 involving multiple peripheral devices working in concert to enhance a game of blackjack is now described. The game management device of the game management system 500 may be in communication with the camera 504, which may be configured to provide a real-time video feed to the game management device of the game management system 500.

The game management device may, based on the received video feed, detect and provide a facial identification of each player proximate to the gaming table 506. The identification data may be sent to one or more other devices (e.g., other computing devices connected via a wired or wireless connection to the game management device) for further processing. Additionally, the game management device may use the identification data to associate an identified player with a pre-existing player account and automatically log that player into the associated player account. Information about each identified player with an associated account may then be provided to one or more displays connected to the game management device 102. For example, the dealer display device 510 may receive a photo or avatar of the player as well as data associated with the player, such as participation in loyalty programs. If a player is not recognized, a prompt may be provided to the dealer (e.g., via the dealer display device 510) to have the unrecognized player register an account.

Players proximate to the table, including identified players, may buy into the game via the game management device 102 or from the player display devices 512, 514, and 516. The system may automatically or otherwise receive buy-in amounts for each player and associate the information with the player and, for identified players, the player's associated player account.

Each player may then place one or more wagers (e.g., a main wager, side bets, progressive cagers, without limitation). The game management system 116 may, via the camera or other identification peripheral device, automatically detect whether the placed bet is above a table minimum amount. If the game management system 116 determines that a bet is below the table minimum, the game management device 102 may provide to the dealer the placed amounts and a notification if a bet is below the table minimum. In some embodiments, players may use one or more peripheral devices in the form of electronic tablets in communication with the game management device 102 to place one or more wagers. The game management system 116 may automatically detect when a wager placed at the electronic tablet is above or below a table minimum or maximum, respectively.

In some embodiments, one or more other peripheral devices may add additional functionality based on information received by the game management device 102. For example, the one or more other peripheral devices may include audio transducers, subwoofers, progressive bet spot indicators may be used to provide indicators where a progressive wager should be placed on a felt table and the audio transducers and/or subwoofers may provide audio cues related to successfully placing a progressive wager. For example, a sound, such as a sound indicative of a coin drop, may play responsive to a detected bet placed into the progressive bet indicator.

When all wagers have been validated, the dealer may start the game. When the dealer begins the game, the wagers of each player are determined and locked in. The game management device may then, via the peripheral devices such as the camera 504, may continually monitor each player and provide real-time data updates to the game management device which may, in turn, provide updated real-time information to the dealer display device 510 and to one or more of the player display devices 512, 514, and 516. The dealer display device 510 may display information such as an indication that not all progressive wagers were collected. Each player display device may display a real-time accounting of the credits (e.g., monetary credits) of each player. Furthermore, all accumulated wagers may be recorded and counted towards a players session rating and associated with the player's player account.

Playing cards may then be dealt to each player. For example, cards (e.g., playing card 536) may be extruded by the card handling device 508 to each player. For example, as shown in FIG. 5, a first player may receive cards 518 (e.g., a first set of cards of a first hand) and a second player may receive cards 520 (e.g., a second set of cards of a second hand). The card handling device 508 may provide data corresponding to a dealt card to the game management device, which may then cause the dealer display device 510 to display each active player and each card held by each player. Furthermore, image data of the cards of each player may be captured by the camera 504 and provided to the game management device, which may detect or verify the card values based on the image data.

After the cards have been dealt, all side bets and progressive wagers may be resolved and the corresponding credits will be added to each player's balance. In some embodiments, while the cards are being dealt, bet spot lights (e.g., light emitting diodes in connection with the game management device) and audio cues may activate when a qualifying hand or card is being formed. As a specific non-limiting example, in “Blazing 7's” (i.e., an optional progressive side bet), when a “7” card is recognized, the bet spot lights may activate a particular color and/or display a particular activation pattern, such as a pattern and color representative of a fire burning, while the audio may play a fire burning sound.

The dealer may check for “blackjack” if the dealer's up-card is a 10-value card or an Ace, and may optionally offer insurance where the game management system 500 may automatically calculate and display via the player display devices 512, 514, and 516 options for insurance and potential payouts.

Once the player's two cards are dealt and the dealer's up card is shown, the side bets and progressive wagers may then be paid. The game management system 500 may automatically suggest a winning progressive hand to an individual player and provide a prompt to the dealer display device 510 for a dealer confirmation. Furthermore, the game management system 500 may also calculate any winning side bets and progressive amounts and display the amount that the dealer should pay via the dealer display device 510. Furthermore, the game management device 102 may receive image data from the camera 504 to verify the winning amount given to a player. Verification of the payout by the camera 504 may be automatically activated upon a payout exceeding a pre-determined payout threshold or may be automatically performed for all payouts.

Each of the players may then choose to “hit” or “stand,” and cards may then be removed and/or dealt out corresponding to each decision. Any changes in cards may be reflected in each of the player display devices 512, 514, and 516 as well as the dealer display device 510.

In some embodiments, the cards may be digital cards “dealt” by the game management device 102 to each of the player display devices 512, 514, and 516 and the dealer display device 510, where the dealt cards are shown as graphics displayed on the display of the player display devices 512 and the dealer display device 510. When it is the player's turn to act, the game management system 500 may limit options selectable via the player's display device. Furthermore, the game management system 500 may instruct the dealer, via the dealer display device 510, how to act based on each player's hand point total, which may reduce the likelihood of the dealer to make a mistake when managing the blackjack game.

At the conclusion of a round, all wagers are resolved and the dealer may collect the cards and end the game round on each of the player display devices 512, 514, and 516 and reset the bet spots via the game management device. Furthermore, the game management device may automatically update progressive signage spots to reflect round outcomes and the system may log and aggregate data collected from the game for further analytics. The data collected from the game may include hands per hour, game performance metrics, and equipment performance alerts.

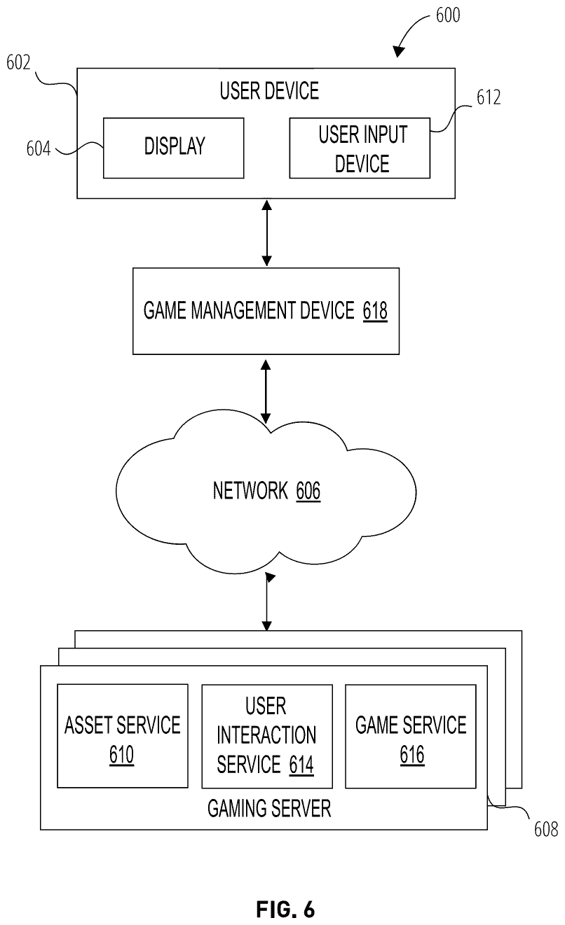

In some embodiments, wagering games in accordance with this disclosure may be administered using a gaming system employing a client-server architecture (e.g., over the Internet, a local area network, etc.). FIG. 6 is a schematic block diagram of an illustrative gaming management system 600 for implementing wagering games according to this disclosure. The gaming management system 600 may enable end users to remotely access game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not limited to, Class II and Class III games as defined under 25 U.S.C. § 2701 et seq. (“Indian Gaming Regulatory Act”). Such games may include banked and/or non-banked games.

The wagering games supported by the gaming management system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming management system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming management system 600 may include a gaming platform to establish a portal for an end user to access a wagering game hosted by one or more gaming servers 608 (e.g., server 114) over a network 606. In some embodiments, games are accessed through a user interaction service 614. The gaming management system 600 enables players to interact with a user device 602 through a user input device 612 and a display 604 and to communicate with a game management device 618 configured to communicate with one or more gaming server 608 using a network 606 (e.g., the Internet). Typically, the user device 602 and the game management device 618 is remote from the gaming server 608 and the network 606 is the word-wide web (i.e., the Internet). In some embodiments, the user device and the game management device 618 may be a single device or same device.

In some embodiments, the gaming servers 608 may be configured as a single server to administer wagering games in combination with the user device 602 and/or the game management device 618. In other embodiments, the gaming servers 608 may be configured as separate servers for performing separate, dedicated functions associated with administering wagering games. Accordingly, the following description also discusses “services” with the understanding that the various services may be performed by different servers or combinations of servers in different embodiments. The gaming servers 608 may include a user interaction service 614, a game service 616, and an asset service 610. In some embodiments, one or more of the gaming servers 608 may communicate with an account server performing an account service. As explained more fully below, for some wagering type games, the account service may be separate and operated by a different entity than the gaming servers 608; however, in some embodiments the account service may also be operated by one or more of the gaming servers 608.

The game management device 618 may communicate with the user interaction service 614 through the network 606. The user interaction service 614 may communicate with the game service 616 and provide game information to the game management device 618. In some embodiments, the game service 616 may also include a game engine. The game engine may, for example, access, interpret, and apply game rules. In some embodiments, a game management device 618 communicates with a game provided by the game service 616, while other embodiments may include a plurality of user devices 602 configured to communicate and provide end users with access to the same game provided by the game service 616 via the game management device 618. In addition, a plurality of end users may be permitted to access a single user interaction service 614, or a plurality of user interaction services 614, to access the game service 616. The user interaction service 614 may enable a user to create and access a user account and interact with game service 616. The user interaction service 614 may enable users to initiate new games, join existing games, and interface with games being played by the user.

The user interaction service 614 may also provide a client for execution on the user device 602 for accessing the gaming servers 608. The client provided by the gaming servers 608 for execution on the game management device 618 may be any of a variety of implementations depending on the game management device 618 and method of communication with the gaming servers 608. In one embodiment, the game management device 618 may connect to the gaming servers 608 using a web browser, and the client may execute within a browser window or frame of the web browser. In another embodiment, the client may be a stand-alone executable on the game management device 618.

For example, the client may comprise a relatively small amount of script (e.g., JAVASCRIPT®), also referred to as a “script driver,” including scripting language that controls an interface of the client. The script driver may include simple function calls requesting information from the gaming servers 608. In other words, the script driver stored in the client may merely include calls to functions that are externally defined by, and executed by, the gaming servers 608. As a result, the client may be characterized as a “thin client.” The client may simply send requests to the gaming servers 608 rather than performing logic itself. The client may receive player inputs, and the player inputs may be passed to the gaming servers 608 for processing and executing the wagering game. In some embodiments, this may involve providing specific graphical display information for the display 604 as well as game outcomes. JAVASCRIPT® is a registered trademark of Oracle America, Inc. of Austin, Texas, USA.

As another example, the client may comprise an executable file rather than a script. The client may do more local processing than does a script driver, such as calculating where to show what game symbols upon receiving a game outcome from the game service 616 through user interaction service 614. In some embodiments, portions of an asset service 610 may be loaded onto the client and may be used by the client in processing and updating graphical displays. Some form of data protection, such as end-to-end encryption, may be used when data is transported over the network 606. The network 606 may be any network, such as, for example, the Internet or a local area network. The gaming servers 608 may include an asset service 610, which may host various media assets (e.g., text, audio, video, and image files) to send to the game management device 618 for presenting the various wagering games to the end user. In other words, the assets presented to the end user may be stored separately from the game management device 618. For example, the game management device 618 requests the assets appropriate for the game played by the user. As another example, especially relating to thin clients, just those assets that are needed for a particular display event will be sent by the gaming servers 608, including as few as one asset. The game management device 618 may call a function defined at the user interaction service 614 or asset service 610, which may determine which assets are to be delivered to the game management device 618 as well as how the assets are to be presented by the game management device 618 to the end user. Different assets may correspond to the various user devices 602 and their clients that may have access to the game service 616 and to different variations of wagering games.

The gaming servers 608 may include the game service 616, which may be programmed to administer wagering games and determine game play outcomes to provide to the user interaction service 614 for transmission to the game management device 618. For example, the game service 616 may include game rules for one or more wagering games, such that the game service 616 controls some or all of the game flow for a selected wagering game as well as the determined game outcomes. The game service 616 may include pay tables and other game logic. The game service 616 may perform random number generation for determining random game elements of the wagering game. In one embodiment, the game service 616 may be separated from the user interaction service 614 by a firewall or other method of preventing unauthorized access to the game service 616 by the general members of the network 606.

The game management device 618 may present a gaming interface to the player and communicate the user interaction from the user input device 612 to the gaming servers 608. The user device 602 may be any electronic system capable of displaying gaming information, receiving user input, and communicating the user input to the game management device 618, which may communicate with the gaming servers 608. For example, the user device 602 may be a desktop computer, a laptop, a tablet computer, a set-top box, a mobile device (e.g., a smartphone), a kiosk, a terminal, or another computing device. The client may be a specialized application (e.g., application 120) or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 608. The client may be illustrated within a casino webpage (or other interface) indicating that the client is embedded into a webpage, which is supported by a web browser executing on the user device 602 or the game management device 618.

In some embodiments, the gaming management system 600 may include a data aggregator configured to aggregate data collected from one or more peripheral devices connected to the game management device 618. The data aggregator may be implemented (e.g., executed) on the game management device 618 or the gaming server 608. The gaming data aggregator may aggregate gaming data from various sources (e.g., peripheral devices 112) and organize the gaming data obtained from the sources for various uses. Some examples of aggregated gaming data includes, but is not limited to, player data, game data, table data, shuffler data, shoe data, sensor data, accounting data, financial data, responsible gaming data, hotel data, offer data, iGaming data, dining data, retail data, sports betting data, e-commerce data, etc. In one embodiment, the aggregated data can be associated with any information obtained via any casino device or related system, such as a casino management system (CMS), a player management system, a game controller, a gaming machine (e.g., game management device 618), a player interface device (e.g., user device 602), a shuffler, a shoe, a sensor, etc. In some embodiments, the gaming data aggregator may obtain gaming data from one or more databases associated with the network 606. The gaming data aggregator may detect events associated with regulated gaming activity (e.g., gaming machine events, slot account system (SAS) events, player interface device events, gaming table events, etc.), store the events, classify the events, and prepare the stored event data into an ingestible form as input variables for machine-learning (ML) model analysis. The gaming data aggregator may also aggregate a combination of real-time data (e.g., data generated during an active gaming session) combined with historical data (e.g., past data stored over a past period). For example, ingested real-time data (e.g., real-time performance of a player or patron) may be distinguished (e.g., separately classified) and evaluated in combination with ingested historical data (e.g., past performance of player/patron) into a single ingestion event prior to being provided to an ML model or prior to being provided to an automated machine learning platform to perform automated feature engineering or extraction analysis.

The gaming data aggregator may further integrate with a table management system (e.g., related to player ratings, chips requests, etc.) and/or a computer-vision or AI based tracking system to receive AI detected actions or activities. The gaming data aggregator may also detect and record chip transfers, bets, markers, redemptions, side bets, average bets, chip transfers to others, seat switches, complimentary offers (comps) or any other transactions or actions that are detectable at the gaming table. In some embodiments, the gaming data aggregator may integrate with cameras, chip tray sensors (e.g., chip tray sensors 534), or other table sensors or devices used to track physical activities performed by table participants. The aggregated data may be used to automatically create player ratings, to track play, to provide bonusing, etc. The aggregated gaming data may be organized for presentation via an analytics dashboard and/or via reports, graphs, etc., to support operators in data driven decisions (e.g., for a gaming table and pit). For example, the gaming data aggregator may organize and present data to a dealer via an electronic dealer display to provide information about players or games metrics.

In some embodiments, components of the gaming management system 600 may be operated by different entities. For example, the user device 602 may be operated by a third party, such as a casino or an individual, that links to the game management device 618, which in turn links to the gaming servers 608, which may be operated, for example, by a wagering game service provider. Therefore, in some embodiments, the game management device 618 and client may be operated by a different administrator than the operator of the game service 616. In other words, the user device 602 may be part of a third-party system that does not administer or otherwise control the gaming servers 608 or game service 616. In other embodiments, the user interaction service 614 and asset service 610 may be operated by a third-party system. For example, a gaming entity (e.g., a casino) may operate the user interaction service 614, user device 602, game management device 618, or combination thereof to provide its customers access to game content managed by a different entity that may control the game service 616, amongst other functionalities. In still other embodiments, all functions may be operated by the same administrator. For example, a gaming entity (e.g., a casino) may elect to perform each of these functions in-house, such as providing access to the game management device 618, delivering the actual game content, and administering the gaming management system 600.

The gaming servers 608 may communicate with one or more external account servers (also referred to herein as an account service), optionally through another firewall. For example, the gaming servers 608 may not directly accept wagers or issue payouts. That is, the gaming servers 608 may facilitate online casino gaming but may not be part of self-contained online casino itself. Another entity (e.g., a casino or any account holder or financial system of record) may operate and maintain its external account service to accept bets and make payout distributions. The gaming servers may communicate with the account service to verify the existence of funds for wagering and to instruct the account service to execute debits and credits. As another example, the gaming servers 608 may directly accept bets and make payout distributions, such as in the case where an administrator of the gaming servers 608 operates as a casino.

Additional features may be supported by the gaming servers 608, such as hacking and cheating detection, data storage and archival, metrics generation, messages generation, output formatting for different end user devices, as well as other features and operations.

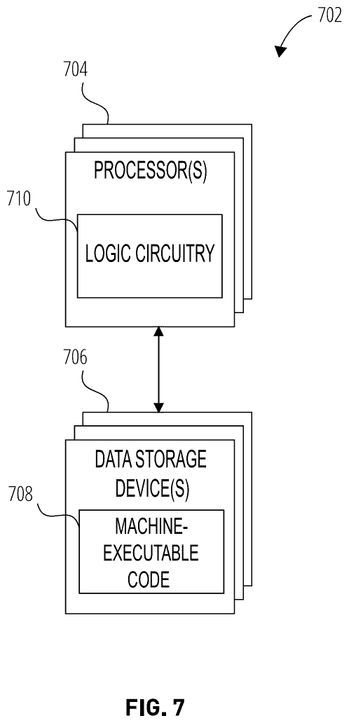

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 7 illustrates non-limiting examples of implementations of functional elements disclosed herein. In some examples, some or all portions of the functional elements disclosed herein may be performed by hardware specially configured for carrying out the functional elements.

FIG. 7 is a block diagram of circuitry 702 that, in some examples, may be used to implement various functions, operations, acts, processes, and/or methods disclosed herein. The circuitry 702 includes one or more processors 704 (sometimes referred to herein as “processors 704”) operably coupled to one or more data storage devices (sometimes referred to herein as “storage 706”). The storage includes machine-executable code 708 stored thereon and the processors 704 include logic circuitry 710. The machine-executable code 708 includes information describing functional elements that may be implemented by (e.g., performed by) the logic circuitry 710. The logic circuitry 710 is adapted to implement (e.g., perform) the functional elements described by the machine-executable code 708. The circuitry 702, when executing the functional elements described by the machine-executable code 708, should be considered as special purpose hardware configured for carrying out functional elements disclosed herein. In some examples, the processors 704 may perform the functional elements described by the machine-executable code 708 sequentially, concurrently (e.g., on one or more different hardware platforms), or in one or more parallel process streams.

When implemented by logic circuitry 710 of the processors 704, the machine-executable code 708 is to adapt the processors 704 to perform operations of examples disclosed herein. For example, the machine-executable code 708 may adapt the processors 704 to perform at least a portion or a totality of the flowchart 300 of FIG. 3. As another example, the machine-executable code 708 may adapt the processors 704 to perform at least a portion or a totality of the operations discussed for the system of FIG. 1. As a specific, non-limiting example, the machine-executable code 708 may adapt the processors 704 to receive data from and provide data to one or more peripheral devices in connection with a game management device of a game management system.

The processors 704 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 708 (e.g., software code, firmware code, hardware descriptions) related to examples of the disclosure. It is noted that a general-purpose processor (may also be referred to herein as a host processor or simply a host) may be a microprocessor, but in the alternative, the processors 704 may include any conventional processor, controller, microcontroller, or state machine. The processors 704 may also be implemented as a combination of computing devices, such as a combination of a DSP and a microprocessor, a plurality of microprocessors, one or more microprocessors in conjunction with a DSP core, or any other such configuration.

In some examples, the storage 706 includes volatile data storage (e.g., random-access memory (RAM)), non-volatile data storage (e.g., Flash memory, a hard disc drive, a solid-state drive, erasable programmable read-only memory (EPROM), etc.). In some examples, the processors 704 and the storage 706 may be implemented into a single device (e.g., a semiconductor device product, a system on chip (SOC), etc.). In some examples, the processors 704 and the storage 706 may be implemented into separate devices.

In some examples, the machine-executable code 708 may include computer-readable instructions (e.g., software code, firmware code). By way of non-limiting example, the computer-readable instructions may be stored by the storage 706, accessed directly by the processors 704, and executed by the processors 704 using at least the logic circuitry 710. Also, by way of non-limiting example, the computer-readable instructions may be stored on the storage 706, transferred to a memory device (not shown) for execution, and executed by the processors 704 using at least the logic circuitry 710. Accordingly, in some examples, the logic circuitry 710 includes electrically configurable logic circuitry 710.

In some examples, the machine-executable code 708 may describe hardware (e.g., circuitry) to be implemented in the logic circuitry 710 to perform the functional elements. This hardware may be described at any of a variety of levels of abstraction, from low-level transistor layouts to high-level description languages. At a high level of abstraction, a hardware description language (HDL) such as an IEEE Standard hardware description language (HDL) may be used. By way of non-limiting examples, VERILOG, SYSTEMVERILOG or very large-scale integration (VLSI) hardware description language (VHDL) may be used.

HDL descriptions may be converted into descriptions at any of numerous other levels of abstraction as desired. As a non-limiting example, a high-level description may be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 710 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the machine-executable code 708 may include an HDL, an RTL, a GL description, a mask level description, other hardware description, or any combination thereof.

In examples where the machine-executable code 708 includes a hardware description (at any level of abstraction), a system (not shown, but including the storage 706) may implement the hardware description described by the machine-executable code 708. By way of non-limiting example, the processors 704 may include a programmable logic device (e.g., an FPGA or a PLC) and the logic circuitry 710 may be electrically controlled to implement circuitry corresponding to the hardware description into the logic circuitry 710. Also, by way of non-limiting example, the logic circuitry 710 may include hard-wired logic manufactured by a manufacturing system (not shown, but including the storage 706) according to the hardware description of the machine-executable code 708.

Regardless of whether the machine-executable code 708 includes computer-readable instructions or a hardware description, the logic circuitry 710 is adapted to perform the functional elements described by the machine-executable code 708 when implementing the functional elements of the machine-executable code 708. It is noted that although a hardware description may not directly describe functional elements, a hardware description indirectly describes functional elements that the hardware elements described by the hardware description are capable of performing.

As used in the disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some examples, the different components, modules, engines, and services described in the disclosure may be implemented as objects or processes that execute on the computing system (e.g., as separate threads). While some of the system and methods described in the disclosure are generally described as being implemented in software (stored on and/or executed by general purpose hardware), specific hardware implementations or a combination of software and specific hardware implementations are also possible and contemplated.

As used in the disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples of the disclosure include:

Example 1: A game management system comprising: a game management device including: one or more processors; and a non-transitory computer-readable medium storing instructions thereon that, when executed by the one or more processors, cause the one or more processors to: detect a plurality of different peripheral devices connected to the game management device; select a game-type from a plurality of game-types; determine a game-state of the selected game-type; receive data from one or more peripheral devices of the plurality of different peripheral devices; and update the game-state responsive to the data received from the one or more peripheral devices.

Example 2: The system according to Example 1, wherein the game management device is configured to control at least some functionality of at least some of the plurality of different peripheral devices.

Example 3: The system according to any of Examples 1 and 2, wherein the plurality of different peripheral devices comprise at least two of an electronic display, light emitting diodes (LEDs), an audio transducer, a subwoofer, a card management device, an image projection device, an image capture device, a chip recognition device, or an audio capture device.

Example 4: The system according to any of Examples 1 through 3, wherein the non-transitory computer-readable medium storing instructions thereon that, when executed by the one or more processors, cause the one or more processors to provide audio and/or visual data to at least some of the plurality of different peripheral devices responsive to updating the game-state.

Example 5: The system according to any of Examples 1 through 4, wherein the non-transitory computer-readable medium storing instructions thereon that, when executed by the one or more processors, cause the one or more processors to provide audio and/or visual data to at least some of the plurality of different peripheral devices responsive to a win condition associated with the selected game-type being satisfied.

Example 6: The system according to any of Examples 1 through 5, wherein the non-transitory computer-readable medium storing instructions thereon that, when executed by the one or more processors, cause the one or more processors to provide the data received from the one or more peripheral devices to one or more other peripheral devices of the plurality of different peripheral devices.

Example 7: The system according to any of Examples 1 through 6, further comprising: one or more sensors configured capture image data of one or more players at a game table; wherein the non-transitory computer-readable medium storing instructions thereon that, when executed by the one or more processors, cause the one or more processors to: identify, based on the captured image data, one or more players at the game table; identify one or more game objects associated with each of the one or more players; determine a chance of satisfying a win condition of the selected game-type for each of the one or more players based on the captured image data, the one or more game objects, and the data received from the one or more peripheral devices; and provide audio and/or video data to at least some of the plurality of different peripheral devices based on the determined chance of satisfying the win condition for each of the one or more players.

Example 8: The system according to any of Examples 1 through 7, wherein the game objects include one or more of a playing card or a game chip.

Example 9: The system according to any of Examples 1 through 8, wherein the one or more sensors comprise one or more image or video capture devices.

Example 10: The system according to any of Examples 1 through 9, wherein the non-transitory computer-readable medium storing instructions thereon that, when executed by the one or more processors, cause the one or more processors to detect peripheral devices of the plurality of different peripheral devices corresponding to the selected game-type.

Example 11: The system according to any of Examples 1 through 10, wherein a peripheral device of the plurality of different peripheral devices comprises a card handling device configured to deal, shuffle or lock one or more cards, the peripheral device comprising: a card receptacle configured to store a plurality of playing cards; one or more image capture devices configured to capture an image of at least part of a card stored in the card receptacle; one or more processors; and a non-transitory computer-readable medium storing instructions thereon that, when executed by the one or more processors, cause the one or more processors to: generate, via the one or more image capture devices, image data of at least part of a card stored in the card receptacle; and provide the image data to the game management device.

Example 12: The system according to any of Examples 1 through 11, wherein the non-transitory computer-readable medium storing instructions thereon of the card handling device that, when executed by the one or more processors, cause the one or more processors to: receive, from the game management device, one or more instructions to deal, shuffle or lock one or more cards stored in the card receptable; and deal, shuffle, or lock one or more cards stored in the card receptable responsive to the one or more instructions.

Example 13: A method of operating a wagering game system including a game table and a game management device, the method comprising: detecting a plurality of peripheral devices connected to the game management device; selecting a game-type from a plurality of game-types; detecting a game-state of the selected game-type; receiving data from one or more peripheral devices of the plurality of peripheral devices; and updating the game-state responsive to the data received from the one or more peripheral devices.

Example 14: A game management system comprising: a plurality of peripheral game devices; a server comprising a non-transitory computer-readable medium storing one or more applications corresponding to different table games; and a game management device in communication with the server and configured to connect to the plurality of peripheral game devices comprising: one or more processors; and a non-transitory computer-readable medium storing instructions thereon that, when executed by the one or more processors, cause the one or more processors to: detect the plurality of peripheral game devices connected to the game management device; select a game-type from a plurality of game-types; request, from the server, one or more applications corresponding to the selected game-type; receive the one or more applications from the server; and provide, based on the one or more applications, game data to one or more peripheral game devices of the plurality of peripheral game devices.

Example 15: The system according to Example 14, wherein the one or more applications includes data corresponding to one or more of side bets, progressive bets, and application configuration data.

Example 16: The system according to any of Examples 14 and 15, wherein at least some of the plurality of peripheral game devices comprise one or more electronic display devices, and wherein the non-transitory computer-readable medium storing instructions thereon of the game management device that, when executed by the one or more processors, cause the one or more processors to provide game data to the one or more electronic display devices, the game data including data corresponding to the selected game-type, one or more side bets, one or more progressive bets, or data corresponding to a current game-state of the selected game-type.

Example 17: The system according to any of Examples 14 through 16, wherein at least some of the plurality of peripheral game devices comprise one or more image capture devices in communication with the game management device, wherein the non-transitory computer-readable medium storing instructions thereon of the game management device that, when executed by the one or more processors, cause the one or more processors to: receive image data from the one or more image capture devices; detect one or more players based on the received image data; detect one or more actions of the one or more players based on the received image data; update a game-state of the selected game-type; and update one or more regions of the one or more electronic display devices responsive to the updated game-state.

Example 18: The system according to any of Examples 14 through 17, wherein the non-transitory computer-readable medium storing instructions thereon of the game management device that, when executed by the one or more processors, cause the one or more processors to: calculate a probability for one or the one or more players to meet a pre-defined win condition based, at least in part, on the received image data; and update one or more regions of the one or more electronic display devices based on the calculated probability.

Example 19: The system according to any of Examples 14 through 18, wherein the non-transitory computer-readable medium storing instructions thereon of the game management device that, when executed by the one or more processors, cause the one or more processors to update the game-state by updating one or more side bets, progressive bets, or one or more parameters associated with the one or more players.

Example 20: The system according to any of Examples 14 through 19, wherein one of the plurality of peripheral game devices comprises a card handling device configured to receive operating instructions from the game management device.

While the disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A game management system comprising:
a game management device including:
one or more processors; and
a non-transitory computer-readable medium storing instructions thereon that, when executed by the one or more processors, cause the one or more processors to:
detect a plurality of different peripheral devices connected to the game management device;
select a game-type from a plurality of game-types;
determine a game-state of the selected game-type;
receive data from one or more peripheral devices of the plurality of different peripheral devices; and
update the game-state responsive to the data received from the one or more peripheral devices.

2. The system of claim 1, wherein the game management device is configured to control at least some functionality of at least some of the plurality of different peripheral devices.

3. The system of claim 1, wherein the plurality of different peripheral devices comprise at least two of an electronic display, light emitting diodes (LEDs), an audio transducer, a subwoofer, a card management device, an image projection device, an image capture device, a chip recognition device, or an audio capture device.

4. The system of claim 2, wherein the non-transitory computer-readable medium storing instructions thereon that, when executed by the one or more processors, cause the one or more processors to provide audio and/or visual data to at least some of the plurality of different peripheral devices responsive to updating the game-state.

5. The system of claim 4, wherein the non-transitory computer-readable medium storing instructions thereon that, when executed by the one or more processors, cause the one or more processors to provide audio and/or visual data to at least some of the plurality of different peripheral devices responsive to a win condition associated with the selected game-type being satisfied.

6. The system of claim 1, wherein the non-transitory computer-readable medium storing instructions thereon that, when executed by the one or more processors, cause the one or more processors to provide the data received from the one or more peripheral devices to one or more other peripheral devices of the plurality of different peripheral devices.

7. The system of claim 1, further comprising:
one or more sensors configured capture image data of one or more players at a game table;
wherein the non-transitory computer-readable medium storing instructions thereon that, when executed by the one or more processors, cause the one or more processors to:
identify, based on the captured image data, one or more players at the game table;
identify one or more game objects associated with each of the one or more players;
determine a chance of satisfying a win condition of the selected game-type for each of the one or more players based on the captured image data, the one or more game objects, and the data received from the one or more peripheral devices; and
provide audio and/or video data to at least some of the plurality of different peripheral devices based on the determined chance of satisfying the win condition for each of the one or more players.

8. The system of claim 7, wherein the game objects include one or more of a playing card or a game chip.

9. The system of claim 7, wherein the one or more sensors comprise one or more image or video capture devices.

10. The system of claim 1, wherein the non-transitory computer-readable medium storing instructions thereon that, when executed by the one or more processors, cause the one or more processors to detect peripheral devices of the plurality of different peripheral devices corresponding to the selected game-type.

11. The system of claim 1, wherein a peripheral device of the plurality of different peripheral devices comprises a card handling device configured to deal, shuffle or lock one or more cards, the peripheral device comprising:
a card receptacle configured to store a plurality of playing cards;
one or more image capture devices configured to capture an image of at least part of a card stored in the card receptacle;
one or more processors; and
a non-transitory computer-readable medium storing instructions thereon that, when executed by the one or more processors, cause the one or more processors to:
generate, via the one or more image capture devices, image data of at least part of a card stored in the card receptacle; and
provide the image data to the game management device.

12. The system of claim 11, wherein the non-transitory computer-readable medium storing instructions thereon of the card handling device that, when executed by the one or more processors, cause the one or more processors to:
receive, from the game management device, one or more instructions to deal, shuffle or lock one or more cards stored in the card receptable; and
deal, shuffle, or lock one or more cards stored in the card receptable responsive to the one or more instructions.

13. A method of operating a wagering game system including a game table and a game management device, the method comprising:
detecting a plurality of peripheral devices connected to the game management device;
selecting a game-type from a plurality of game-types;
detecting a game-state of the selected game-type;
receiving data from one or more peripheral devices of the plurality of peripheral devices; and
updating the game-state responsive to the data received from the one or more peripheral devices.

14. A game management system comprising:
a plurality of peripheral game devices;
a server comprising a non-transitory computer-readable medium storing one or more applications corresponding to different table games; and
a game management device in communication with the server and configured to connect to the plurality of peripheral game devices comprising:
one or more processors; and
a non-transitory computer-readable medium storing instructions thereon that, when executed by the one or more processors, cause the one or more processors to:
detect the plurality of peripheral game devices connected to the game management device;
select a game-type from a plurality of game-types;
request, from the server, one or more applications corresponding to the selected game-type;
receive the one or more applications from the server; and
provide, based on the one or more applications, game data to one or more peripheral game devices of the plurality of peripheral game devices.

15. The system of claim 14, wherein the one or more applications includes data corresponding to one or more of side bets, progressive bets, and application configuration data.

16. The system of claim 15, wherein at least some of the plurality of peripheral game devices comprise one or more electronic display devices, and wherein the non-transitory computer-readable medium storing instructions thereon of the game management device that, when executed by the one or more processors, cause the one or more processors to provide game data to the one or more electronic display devices, the game data including data corresponding to the selected game-type, one or more side bets, one or more progressive bets, or data corresponding to a current game-state of the selected game-type.

17. The system of claim 16, wherein at least some of the plurality of peripheral game devices comprise one or more image capture devices in communication with the game management device, wherein the non-transitory computer-readable medium storing instructions thereon of the game management device that, when executed by the one or more processors, cause the one or more processors to:
receive image data from the one or more image capture devices;
detect one or more players based on the received image data;
detect one or more actions of the one or more players based on the received image data;
update a game-state of the selected game-type; and
update one or more regions of the one or more electronic display devices responsive to the updated game-state.

18. The system of claim 17, wherein the non-transitory computer-readable medium storing instructions thereon of the game management device that, when executed by the one or more processors, cause the one or more processors to:
calculate a probability for one or the one or more players to meet a pre-defined win condition based, at least in part, on the received image data; and
update one or more regions of the one or more electronic display devices based on the calculated probability.

19. The system of claim 17, wherein the non-transitory computer-readable medium storing instructions thereon of the game management device that, when executed by the one or more processors, cause the one or more processors to update the game-state by updating one or more side bets, progressive bets, or one or more parameters associated with the one or more players.

20. The system of claim 17, wherein one of the plurality of peripheral game devices comprises a card handling device configured to receive operating instructions from the game management device.
